(19) United States
(12) Patent Application Publication
(10) Pub. No.: US 2009/0165121 A1
(43) Pub. Date: Jun. 25, 2009

(54) Touch Pad based Authentication of Users

(75) Inventor: Rakesh Kumar, Hyderabad (IN)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA Corporation, Santa Clara, CA (US)

(21) Appl. No.: 11/962,128

(22) Filed: Dec. 21, 2007

(51) Int. Cl. H04L 9/32; G06F 7/04

(52) U.S. Cl. 726/19; 713/182

(57) ABSTRACT

Touch pad based authentication of users. In an embodiment, a user can touch (and move on) a touch pad in a specific pattern (e.g., up, down, etc.) to authenticate oneself. In an embodiment, a device translates the touch movement to the same set of characters as those a user can manually enter using a keyboard to authenticate oneself. As a result, the user can use the same password when accessing the same application from other systems which have only keyboards, but not touch pads.

### BACKGROUND

1. Field of Disclosure

The present disclosure relates generally to authentication of users, and more specifically to touch pad based authentication of users.

2. Related Art

Authentication refers to verifying that a user is the one the user purports to be. In one scenario, a user enters a user identifier and a password combination for authentication. Each of the user identifier and the password typically contains a sequence of characters. The user identifier usually identifies the user uniquely in the system (and can be known to others) while the password is typically confidential to the user such that the user can confirm his/her identity by providing a matching (identical) string as the password.

Authentication is often used to control access of applications, systems (servers, desktops, laptops, etc.), devices (handhelds, PDAs, cellular phones, etc.), etc., only to authorized users, as is well known in the relevant arts.

Touch-pads refer to components which detect touch actions (on its surface) and provide corresponding signals for further processing. The touch pads are often integrated with display features, in which case the component is referred to as a touch-screen.

It is often desirable to enable a user to provide authentication data using a touch pad, for authentication of users.

### BRIEF DESCRIPTION OF THE DRAWINGS

Example embodiments will be described with reference to the following accompanying drawings, which are described briefly below.

FIG. 1 is a block diagram illustrating an example environment/system in which several aspects of the present invention may be implemented.

FIG. 2 is a flowchart illustrating the manner in which touch data may be processed to provide authentication data for authentication of users in an embodiment of the present invention.

FIG. 3 is a block diagram illustrating the details of example architecture for touch screen based authentication of users in an embodiment of the present invention.

FIGS. 4A, 4B and 4C are respective tables depicting configuration tables stored in the memory of a digital processing system for authenticating users in corresponding embodiments of the present invention.

FIG. 5 is a block diagram illustrating the example usage of a touch screen based authentication of users in an embodiment of the present invention.

FIG. 6 is a block diagram illustrating the details of a handheld (example device with a touch screen) providing touch screen based authentication of users, in an embodiment of the present invention.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### Overview

An aspect of the present invention enables a user to touch (and move on) a touch pad in a specific pattern (e.g., up, down, etc.) to authenticate oneself. In an embodiment, a device translates the touch movement to the same set of characters as those a user can manually enter using a keyboard to authenticate oneself. As a result, the user can use the same password when accessing the same application from other systems which have only keyboards, but not touch pads.

Several aspects of the invention are described below with reference to examples for illustration. It should be understood that numerous specific details, relationships, and methods are set forth to provide a full understanding of the invention. One skilled in the relevant arts, however, will readily recognize that the invention can be practiced without one or more of the specific details, or with other methods, etc. In other instances, well-known structures or operations are not shown in detail to avoid obscuring the features of the invention.

### 2. Example Eenvironment

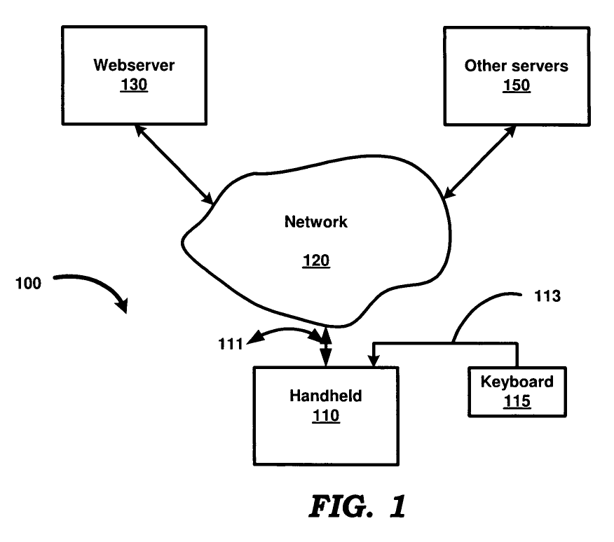

FIG. 1 is a block diagram of an example environment/system in which several aspects of the present invention may be implemented. The system is shown containing handheld 110, keyboard 115, network 120, web server 130 and other servers 150. Each block is described in further detail below.

The block diagram is shown containing only representative blocks for illustration. However, real-world environments may contain more/fewer/different components/blocks, both in number and type, depending on the purpose for which the hand held is designed, as will be apparent to one skilled in the relevant arts.

Web server 130 executes various applications, which can be accessed from handheld 110 according to a suitable user interface. For example, web server 130 may generate various web pages, which are transmitted on network 120 to handheld 110 and a user may interact with the applications using a web browser implemented on the handheld.

Other servers 150 represent server systems such as a data base server (which generally provides a centralized storage of data such that several other systems, for example, client systems or server systems, can access the data bases), application server (which contains software applications capable of performing operations requested by client systems such as handheld 110), etc. These servers also may execute applications which are accessed by a user of handheld 110 or may provide data for other applications.

Network 120 provides connectivity between web server 130, other servers 150 and handheld 110. Network 120 may be implemented using protocols such as Internet Protocol (IP) well known in the relevant arts. Path 111 may be implemented as a wireless path using well known protocols, for example, wireless LAN (Local Area Network) protocols such as 802.11 from IEEE (Institute of Electrical and Electronics Engineers), cellular phone network protocols such as GSM (Global System for Mobile communications) and CDMA (Code Division Multiple Access), etc. Alternately, path 111 may also use a wired path using for example, LAN protocols such as 802.03 from IEEE, etc.

In general, Network 120 and path 111 represent communication paths using which a user of handheld 110 may communicate with web server 130 and other servers 150 to access various services (applications) such as email, news, photo albums, etc., which may require the user to be authenticated before allowing access. Web server 130, other servers 150, network 120 and path 111 may be implemented in a known way.

Keyboard 115 contains a set (one or more) of keys, using which a user can provide input data. In general, pressing one or more keys causes a corresponding character to be provided for further processing within handheld 110. The set of all characters that can be provided using a keyboard may be referred to as an alphabet of the keyboard.

Keyboard 115 may be used to provide authentication data (for example, a user name, corresponding password, etc.). Keyboard 115 may also be used to provide alphanumeric inputs (for example, to compose a message or store contact details), provide user choices (such as up, down, select, cancel, etc.) or make voice calls (if handheld 110 incorporates telephony functionality), etc. Though shown as a separate component, key board 115 may be integrated within handheld 110.

Handheld 110 represents an example device with a touch screen (an example of a touch pad), in which several aspects of the present invention may be implemented. The user may access various applications executing either on handheld or on servers 130/150. As relevant to the present invention, some of the applications may require the user to authenticate prior to permitting further access.

In an embodiment, the user may use keyboard 115 to provide user identifier and password as authentication data.

According to one aspect of the present invention, a user may provide at least a portion of authentication data using the touch screen on handheld 110, as described below. In particular, the description is provided assuming that the user provides only the password using a touch pad. However, the features can be extended to provide other parts of authentication data (e.g., user identifier) in alternative embodiments, as will be apparent to one skilled in the relevant arts by reading the disclosure provided herein.

### 3. Using a Touch Screen to Provide Authentication Data

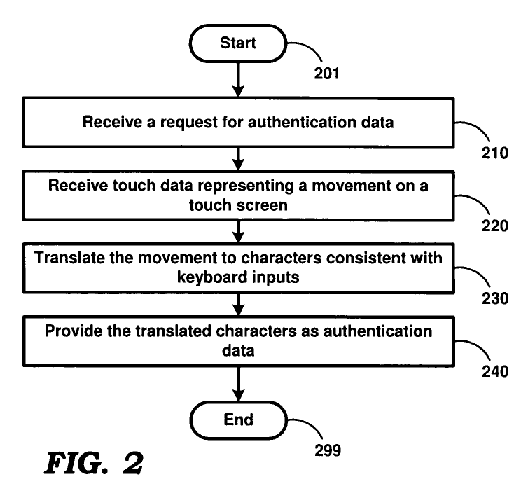

FIG. 2 is a flowchart illustrating the manner in which touch data may be processed to provide authentication data for authentication of users, in an embodiment of the present invention. The flowchart is described with respect to FIGS. 1-2 merely for illustration. However, various features can be implemented in other environments and with other components/blocks without departing from several aspects of the present invention. Furthermore, the steps are described in a specific sequence merely for illustration.

Alternative embodiments in other environments, using other components and different sequence of steps can also be implemented without departing from the scope and spirit of several aspects of the present invention, as will be apparent to one skilled in the relevant arts by reading the disclosure provided herein. The flowchart starts in step 201, in which control passes immediately to step 210.

In step 210, handheld 110 receives a request for authentication data. The request can be received according to any pre-specified convention consistent with the implementation on handheld 110. For example, assuming that handheld 110 implements a web browser and displays web pages, the HTML content providing the web page description may contain tags to request the user identifier and the corresponding password. The request can be received from an application executing internal to handheld 110 as well.

In step 220, handheld 110 receives touch data representing a movement on a touch screen. In general, a user touches the touch screen on contiguous locations at corresponding successive time instances to represent a movement (before removal of the object used to touch). The touch screen on handheld 110 is designed to facilitate detection of touch actions. In an embodiment, the touch screen may be implemented to provide information (touch data) representing the movement (in terms of the specific time instances of touch at corresponding coordinates, etc.) of an object on the touch screen, which may be received according to any convention.

In step 230, handheld 110 translates the movement to characters consistent with keyboard inputs. As noted above, the user can provide authentication data using keyboard, which provides for specific characters depending on the specific keys pressed. At least to ensure compatibility with the applications requiring passwords in the form of such characters, handheld 110 may translate the movement into the same alphabet of characters as that provided using the keyboard.

According to an aspect of the present invention, the translation is based on other than examining for similarity of the pattern of movement compared to the character patters (commonly referred to as character recognition). For example, assuming the movement can be only one of horizontal, vertical, right or left movement (four possible movements), the coordinates of movement can be fit/approximated into a line. The direction of the movement can be determined based on the time instances associated with the touch at each coordinate. From the line and the direction, the movement can be mapped to one of the four possible movements in a known way. In general, various well-known approaches can be used in determining the movement patterns (including curves, etc., not related to the pattern of the character) as will be apparent to one skilled in the relevant arts by reading the disclosure provided herein.

In step 240, handheld 110 provides the translated characters as authentication data, to the application which requested for authentication data. If the application which requested the authentication data is executing in a system external to handheld 110 (for example, web server 130 or other servers 150), the authentication data may be forwarded over path 111 and network 120 to the corresponding system. If the password is being requested by an internal application, the mapped characters are provided to such application. The flowchart ends in step 299.

Thus a user may make a movement on a touch screen in handheld 110 (using stylus type implements or even hand), to provide at least a portion of the authentication data to an application, without using a keyboard.

The features described above can be implemented using various architectures. An example architecture of handheld 110 providing such features to a user invention, is described below with examples.

### 4. Handheld Architecture

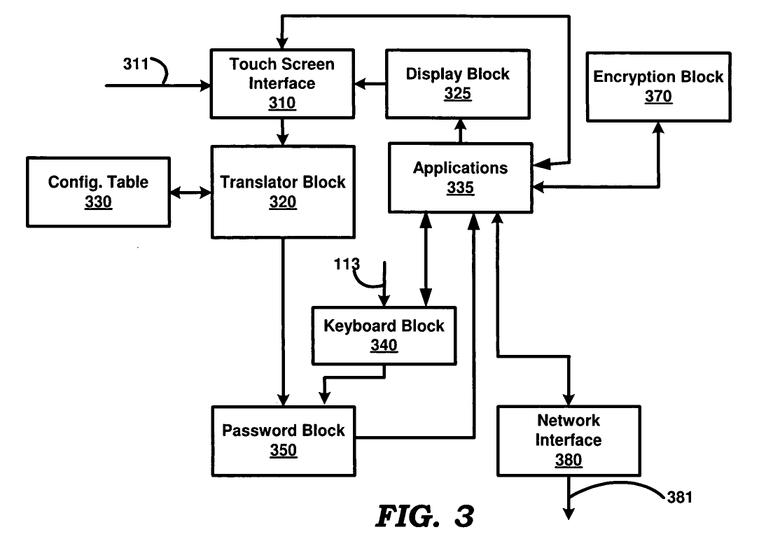

FIG. 3 is a block diagram illustrating the details of an example architecture for touch screen based authentication of users, in an embodiment of the present invention. Handheld 110 is shown containing touch screen interface 310, translator block 320, display block 325, config (configuration) table 330, local applications 335, keyboard interface 340, password block 350, encryption block 370 and network interface 380. Each block is described in further detail below.

Again, merely for illustration, only representative number/types of blocks are shown in FIG. 2. However, handheld architecture, according to several aspects of the present invention can contain many more/fewer/different blocks, both in number and type, depending on the purpose for which the environment is designed, as will be apparent to one skilled in the relevant arts.

Local applications 335 represent various applications executing in handheld 110. An application can be a self-contained user application (e.g., calendar software, MP3 Player, etc.) or web-browser type software using which external applications (on servers 130/150) can be accessed. In general, local applications 335 generate corresponding display portions, which are displayed on touch screen by interfacing with display block 325.

A local application receives password data from password block 350 irrespective of whether the password is provided using a keyboard or touch pad. The local application receives any additional user inputs from the keyboard as suited for the specific situation. An application may indicate to touch screen interface 310 when a password is to be potentially received using touch pad and then receive the password characters from password block 350.

When a password is to be sent in encrypted form, the application interfaces with encryption block 370 to generate an encrypted password. For example, in case the application corresponds to a web browser, a received web page may indicate a specific tag (password tag) indicating that text representing a password is to be received from a user and be sent in encrypted form. In response, the web browser application may receive password text from keyboard block 340, use encryption block 370 to form encrypted password text, and sends the encrypted text via network interface 380.

Keyboard block 340 interfaces with keyboard 115 over path 113. Keyboard block 340 receives signals representing a set of keys pressed by a user, and generates a corresponding character of the alphabet of keyboard 115. The generated characters are provided to password block 350 or local applications 335 depending on the specific context in which the keys were pressed. In case a password is being requested, the characters are provided to password block 350. On other hand, other types of user inputs may be directly provided to the corresponding application requesting the user input.

Display block 325 generates display signals based on the display data received from local applications 335. The display signals cause corresponding images to be displayed on the touch screen. In an embodiment, display block 325 contains a frame buffer in which various applications write pixel values representing the corresponding image portions. Display block 325 constructs an image frame to be displayed based on the pixel values, and generates display signals corresponding to the image frame. Display block 325 may be implemented in a known way.

Network interface 380 interfaces with network 120 over path 111 to communicate with web server 130/other servers 150 to access various services (applications) such as email, news, photo albums, etc. Network interface 380 may contain various protocol stacks (such as IP stack, etc.) and software routines and calls which are necessary for communication between handheld 110 and web server 130/other servers 150. The data/instructions received from web server 130/other servers 150 (such as request for authentication data) is forwarded to local applications 335 for further processing. Similarly, network interface 380 forwards the data (for example, encrypted authentication data from 370, data from a web page being displayed by (a web browser) application 335, etc.) from local applications 335 to web server 130/other servers 150.

Encryption block 370 encrypts (transforms data into a form such that the contents remain confidential and may be revealed only on decryption, by which the encrypted data is transformed back into the original form) the data (portion of authentication data) received from password block 370 and forwards the encrypted data to network interface 380 for communicating to web server 130/other servers 150. The authentication data is encrypted to prevent others (other than the target web server 130/other servers 150) from intercepting the authentication data (for unauthorized use). Encryption block 370 may be implemented in a known way.

Password block 350 receives the authentication data from translation block 320 (generated from touch gestures by translator block 320, if a user performs a movement on touch screen of handheld 110 to input authentication data) or from keyboard block 340 (generated by a user pressing keys on keyboard 115, if the user inputs authentication data from keyboard 115)). Password block 350 provides the authentication data to application 335.

Touch screen interface 310 receives touch data indicating the coordinates on the touch pad at which touch has been sensed and corresponding time points over path 311, and converts the touch data to appropriate higher level abstractions as suited to the processing of the subsequent blocks. In an embodiment, as relevant to authentication data, touch screen interface 310 converts the received touch data into a series of one or more directions (U-Up, D-Down, L-Left, R-Right) referred to as a touch gesture.

However, in alternative embodiments, more complex directions can also be ascertained according to a corresponding pre-specified convention. In general, the conversion entails examining the coordinates of touch to determine the best fit among possible gestures, and can be implemented in a known way. The touch gesture may be forwarded to translator block 320. Touch screen interface 310 is implemented taking into consideration the interfacing requirements of the touch screen as well as other blocks of hand held 110.

In case an application indicates that a password is expected, the data representing the higher level abstraction (hand gesture) may be forwarded to the translator block. In other cases, the data representing the higher level abstraction is provided to the specific application, for further processing.

Touch screen interface 310 also receives the display signals generated by display block 325 and causes a corresponding image to be generated on the touch screen. In general, touch screen interface 310 needs to be implemented consistent with the interface requirements of the touch screen.

Translator block 320 receives the touch gesture and generates authentication data, consistent with the alphabet of keyboard 115. As may be appreciated, different touch gestures should correspond to different authentication data. Accordingly, in an embodiment, a configuration table is maintained with configuration table 330 to map the touch gesture to corresponding authentication data. The mapped authentication data is then provided to password block 350.

Thus, config table 330 stores configuration data (indicating the various touch gestures and the corresponding authentication data) required for translation block 320 to generate authentication data from received touch gestures. The description is continued with examples of configuration tables, and the manner in which different types of authentication data can be generated based on the requirements of the corresponding environment.

### 5. Configuration Tables

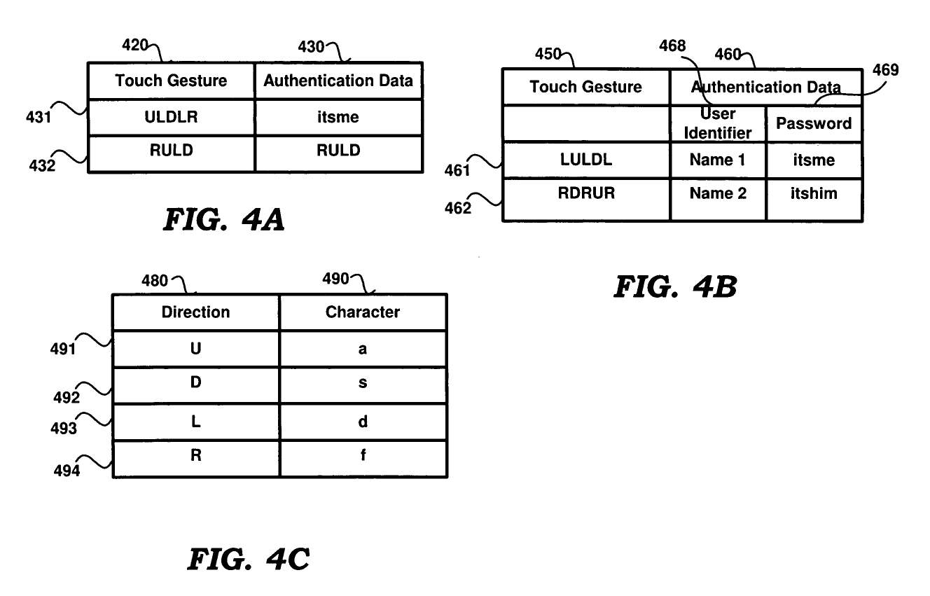

FIGS. 4A-4C depict logically the configuration tables stored in a memory of handheld 110, in an embodiment. There may be a separate configuration table for different users and each of the tables may be user configurable to provide additional flexibility to respective users. The configuration tables for each of the users themselves may be password protected to prevent others from gaining access to the configuration tables.

Each configuration table is shown having two columns. The left column lists the touch gesture that a user may make on the touch screen of handheld 110 and the right column lists the corresponding authentication data that may be provided to an application.

FIG. 4A depicts a configuration table which may be used to generate a password (portion of authentication data) from a touch gesture, consistent with the alphabet of keyboard 115, as described above. The table is shown having two columns touch gesture 420, and authentication data 430 and two rows, 431-432. Row 431 shows that a touch gesture “ULDLR” i.e. a sequence of five directions Up, Left, Down, Left, and Right by a user on the touch screen of handheld 110, may be translated as authentication data “itsme”, by translator block 320 and provided to password block 350. Row 432 shows that another touch gesture “RULD” i.e. a sequence of four directions Right, Up, Left, and Down by a user may be translated as characters “RULD” and provided to password block 350. The translated text (column 430) may correspond to a password for the gesture in the same row.

FIG. 4B depicts a configuration table that may be used to generate a user identifier and password as authentication data from a touch gesture, consistent with the alphabet of keyboard 115, as described above. The table is shown having two columns touch gesture 450, and authentication data 460 and two rows, 461-462. Column 460 authentication data is shown containing two sub columns user identifier 468 and password 469. Row 461 shows that a touch gesture “LULDL” i.e. a sequence of five directions Left, Up, Left, Down, and Left by a user on the touch screen of handheld 110, may be translated as a user identifier “Name 1” and password “itsme”, by translator block 320 and provided to password block 350.

Similarly, Row 462 shows that another touch gesture “RDRUR” i.e. a sequence of four directions Right, Down, Right, Up, and Right by a user may be translated as a user identifier “Name 2” and password “itshim” and provided to password block 350.

It may be appreciated that configuration tables depicted in FIGS. 4A-4B maps a touch gesture into a block of characters consistent with the alphabet of keyboard 115. There is no one to one correspondence between each constituent direction (for example, U, D, L, R) and a corresponding character of the respective block of characters. Yet another alternative embodiment may map gestures to corresponding characters and provide further flexibility for users to choose passwords.

FIG. 4C depicts a configuration table in which each constituent direction (for example, U, D, L, R) of a touch gesture corresponds respectively to a character (a, s, d, f respectively in the example). The table is shown having two columns touch gesture 480, and character 490 and four rows, 491-494. Row 491 shows that a direction “U” i.e. Up (part of a touch gesture on touch screen of handheld 110), corresponds to character “a”. Similarly, rows 492-494 show that “D” corresponds to character “s”, “L” corresponds to character “d” and “R” corresponds to character “f”. For example, touch gesture “RULD” may be translated as “fads”, by replacing each of the directions (column 480) with respective characters (column 490).

Using configuration tables as depicted in FIGS. 4A-4C, translator block 320 may translate a touch gesture performed by a user on the touch screen of handheld 110 into a portion of authentication data, and provide the authentication data to the requesting application, as described above. As further described above, the same password text can also be provided using the keyboard. The description is continued with an example user experience of touch screen based authentication of users in one embodiment of the present invention.

### 6. Example User Experience

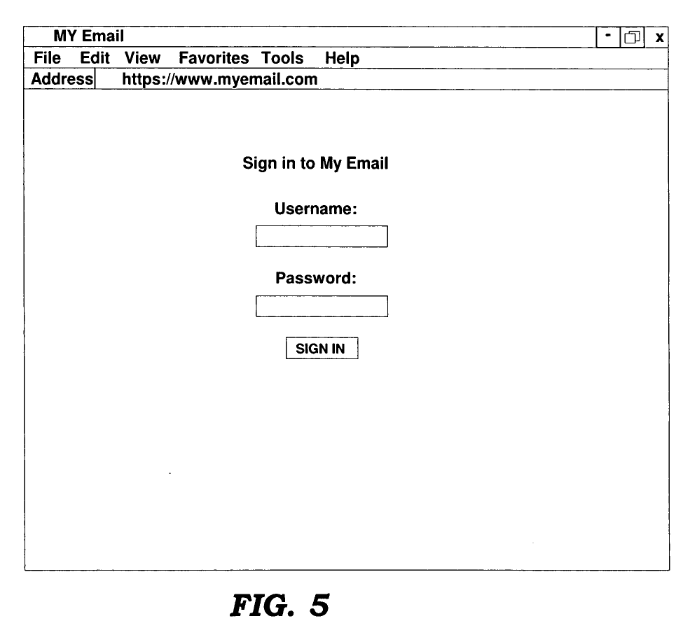

FIG. 5 depicts the manner in which a user may input authentication data in one embodiment of the present invention. The display there represents a web page displayed by a web browser application (335) on the touch screen of handheld 110. It is assumed that the entire touch screen there is a touch pad.

As shown there, the user is being requested a user name and password. Thus, assuming the table of FIG. 4A is the operative configuration table and that a user moves a stylus (while touching the screen) in a right, up, left and down (as in a rectangle), the corresponding touch data is translated to a password of RULD. The password is provided to the web browser requesting the password. On the other hand, if the table of FIG. 4C is operative, a password of fads is generated. In both these scenarios, the user is required to provide the user name in addition, for example, using a keyboard (or cookies).

Alternatively, assuming the configuration data of FIG. 4B is operative, if the user has a gesture of left, up, left, down and left, a user identifier of “Name 1” and password of “itsme” are generated.

It should be appreciated that handheld 110 can be implemented with a desired combination of software/hardware and firmware as suited for the specific scenario. The description is continued with respect to an embodiment in which several features of the present invention are operative upon execution of appropriate software instructions.

### 7. Software Implementation

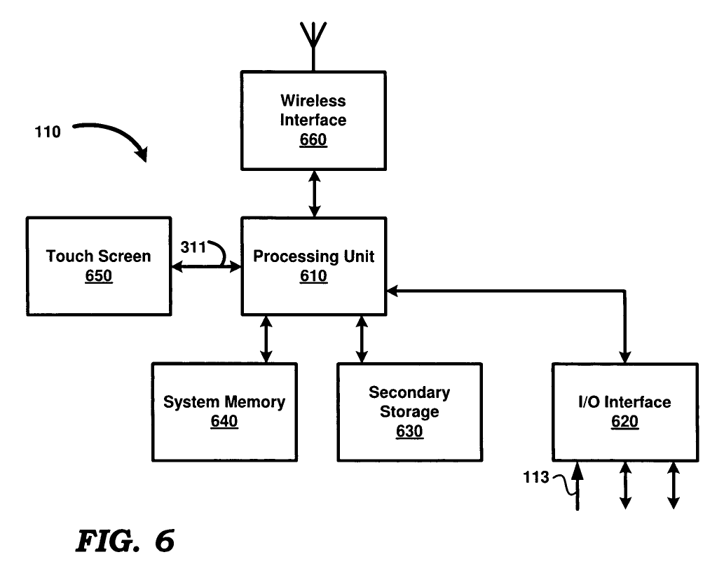

FIG. 6 is a block diagram illustrating the details of a handheld (example device with a touch screen) in an embodiment of the present invention. Handheld 110 is shown containing processing unit 610, I/O interface 620, secondary storage 630, system memory 640, touch screen 650, and wireless interface 660. Each block is described in further detail below.

Merely for illustration, only representative number/type of blocks are shown in the Figure. Many environments often contain many more /fewer/different blocks, both in number and type, depending on the purpose for which the environment is designed, as will be apparent to one skilled in the relevant arts. For example, though the device is shown to operate with a wireless interface, handheld 110 may be implemented using a wired interface.

Wireless interface 660 provides the physical (antenna, etc.), electronic (transmitter, receiver, etc.) and protocol (GSM, CDMA, etc.) interfaces necessary for handheld device 110 to communicate with web server 130 and other servers 150 over network 120. In an embodiment, processing unit 610 may enable a user to communicate through voice, SMS, data, email, etc., using a user interface (not shown) presented on touch screen 650. Many such interfaces will be apparent to one skilled in the relevant arts. Thus, handheld 110 may optionally operate as a mobile phone, in addition to Internet access device (for email and web-browsing).

Touch screen 650 represents a touch pad integrated with a display screen. A user may, using a stylus or body (for example, fingers) make movements on touch screen 650, while remaining touched. Touch screen 650 may forward the touch data (indicating the coordinates on the touch pad at which touch has been sensed and corresponding time points) to processing unit 610, for generating authentication data.

I/O (Input/Output) interface 620 provides the physical, electrical and protocol interfaces necessary to communicate with other devices using well known interfaces (for example, USB, wired or wireless Ethernet, Bluetooth, RS232, parallel interface, etc.). I/O interface 620 also provides the physical, electrical and protocol interfaces necessary for operation of keyboard 115 overpath 113, to enable a user to provide inputs to handheld 110 ( for example authentication data) by pressing the appropriate key/s.

System memory 640 contains randomly accessible locations to store program (instructions) and/or data, which are used by processing unit 610 during operation of handheld 110. The data and instructions may be retrieved from secondary storage 630. The data retrieved may correspond to various configuration tables described above. The instructions, when executed, may similarly support the various applications (local applications, web browser, touch screen interface, various blocks such as translator block, etc.). System Memory 640 may contain RAM (e.g. SRAM, SDRAM, DDR RAM, etc.), non-volatile memory (e.g. ROM, EEPROM, Flash Memory, etc.) or both.

Secondary storage 630 may contain hard drives, flash memory, removable storage drives, etc. Secondary memory 630 may store (on a non-volatile memory) the data and software instructions, which enable handheld 110 to provide several features in accordance with the present invention. Secondary storage 610 may also store configuration tables. In general, memory units (including RAMs, non-volatile memory, removable or not) from which instructions can be retrieved and executed by processors are referred to as a computer (or in general, machine) readable medium.

Processing unit 610 at least in substantial respects controls the operation (or non operation) of the various other blocks (in handheld 110) by executing instructions stored in system memory 640, to provide various features of the present invention. Some of the instructions executed by processing unit 610 also represent various user applications (e.g., web browser, etc.) provided by handheld 110. Processing unit 610 may contain one multiple processors, with each processor potentially being designed for a specific task.

Thus, using the example approaches of above, at least a portion of authentication data may be conveniently generated based on touch gestures on a touch pad. Such a feature may be of particular convenience when small keyboards (or input portions) are present (e.g., in devices such as handhelds, cell phones, etc.).

### 7. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of authenticating a user, said method comprising:
receiving a touch data representing a movement on a touch pad;
translating said movement to a set of characters consistent with an alphabet of a keyboard; and
providing said set of characters as an authentication data of said user.

2. The method of claim 1, wherein said translating is other than by comparing a pattern of said movement with a pattern representing any of said set of characters.

3. The method of claim 1, wherein said translating comprises:
converting said movement to a set of directions;
examining a configuration table in a memory to determine an entry matching said set of directions,
wherein said configuration table contains a plurality of entries including said entry, wherein each entry indicates a set of characters to be included in said authentication data for a corresponding one or more directions.

4. The method of claim 3, wherein said authentication data includes a password formed by a plurality of characters, wherein said plurality of characters are determined based on the content of said configuration table.

5. The method of claim 4, wherein said authentication data further includes an identifier of said user.

6. The method of claim 5, wherein a set of directions of said movement together is mapped to both said identifier and said password.

7. The method of claim 3, wherein a direction of said movement is mapped to a corresponding character forming said authentication data.

8. The method of claim 3, wherein a request for said authentication data is received from an external server, and said set of characters are sent as a response to said request.

9. The method of claim 8, further comprising encrypting said set of characters to form an encrypted data, and sending said encrypted data to said external server.

10. The method of claim 3, wherein a request for said authentication data is received from an application executing within a device containing said touch pad, wherein said set of characters are sent as a response to said request.

11. A machine readable medium carrying one or more sequences of instructions for causing a device to facilitate authentication of a user, said device containing a touch pad, wherein execution of said one or more sequence of instructions by one or more processors contained in said device causes said device to perform the actions of:
receiving a touch data representing a movement on said touch pad;
translating said movement to a set of characters consistent with an alphabet of a keyboard; and
providing said set of characters as an authentication data of said user.

12. The machine readable medium of claim 11, wherein said translating comprises:
converting said movement to a set of directions;
examining a configuration table in a memory to determine an entry matching said set of directions,
wherein said configuration table contains a plurality of entries including said entry, wherein each entry indicates a set of characters to be included in said authentication data for a corresponding one or more directions.

13. The machine readable medium of claim 12, wherein said authentication data includes a password formed by a plurality of characters, wherein said plurality of characters are determined based on the content of said configuration table.

14. The machine readable medium of claim 13, wherein said authentication data formed by said translating includes both an identifier and a password of said user.

15. A device comprising:
a touch pad on which a user causes a touch movement; and
a processing unit to receive a touch data representing said touch movement and to form an authentication data based on said touch movement.

16. The device of claim 15, further comprising:
a keyboard block to interface with a keyboard having an associated alphabet, wherein said processor is designed to receive characters consistent with said alphabet in response to said user operating corresponding keys on said keyboard,
wherein said processing unit forms said authentication data as a set of characters consistent with said alphabet.

17. The device of claim 16, wherein said processing unit determines a set of directions in said touch movement, said device further comprising:
a memory containing a configuration table, wherein said configuration table includes a plurality of entries with each entry identifying a subset of characters corresponding to a subset of said directions,
wherein said processing unit forms said set of characters based on said configuration table in response to determination of said set of directions.

18. The device of claim 17, wherein said authentication data includes a password of said user, wherein said processing unit provides said set of characters as said password.

19. The device of claim 18, wherein said authentication data also includes an identifier of said user, said memory storing said identifier and said password in an entry corresponding to said set of directions in said memory.

20. The device of claim 18, wherein said processing unit receives a request for said authentication data from an external device, wherein said processing unit sends said password in encrypted form as a response to said request.
